(19) United States
(12) Patent Application Publication
(10) Pub. No.: US 2012/0106022 A1
(43) Pub. Date: May 3, 2012

(54) STRUCTURE MADE OF COMPOSITE MATERIAL PROTECTED AGAINST THE EFFECTS OF LIGHTNING

(75) Inventors: Daniel Aliaga, Aubervilliers (FR); Frederick Cavaliere, Montigny Le Bretonneux (FR)

(73) Assignee: EUROPEAN AERONAUTIC DEFENCE AND SPACE COMPANY EADS FRANCE, Paris (FR)

(21) Appl. No.: 13/143,802

(22) PCT Filed: Jan. 7, 2010
(86) PCT No.: PCT/EP2010/050109

§ 371 Date: Jan. 19, 2012

(30) Foreign Application Priority Data
Jan. 9, 2009 (FR) 0950106

(51) Int. Cl. H05F 3/00; H02G 13/00

(52) U.S. Cl. 361/218; 174/2

(57) ABSTRACT

A part (1) includes a structural portion made of an electrically insulating or low-conductive composite material (2) and includes, on a surface (11) of the structural portion likely to be subjected to lightning impacts (10), a metallization layer (30) covered with an electrically insulating protection paint (4). The metallization layer includes a layer of a first electrically conductive metal material (31), referred to as HVT material, and includes at least one second electrically conductive metal material (32), referred to as LVT material, having a vaporization temperature Θl substantially lower than the vaporization temperature Θh of the first electrically conductive HVT metal material. A lightning impact results in the vaporization of the LVT material and the removal of the paint on a surface larger than that in which the HVT material is vaporized, and therefore exposes or lifts a portion of the metallization around the lightning impact point, thereby promoting the anchoring of the lightning arc base.

The present invention relates to the field of structures made with composites. More particularly the invention relates to structures made from electrically non-conductive or poorly conductive materials that are liable to be struck by lightning during their use.

The invention in particular relates to structures, made of composites, for aircraft.

Among the many families of composites, the family of composites comprising fibers of an inorganic (glass, silica, carbon, etc.) or organic (aramid, Kevlar®, etc.) material that one held in a hard organic matrix (polyester, epoxy resin, etc.) is widely used to produce structures because of their mechanical properties, in particular their weight-bearing properties, and/or because it is possible to produce complex shapes with them.

These features and advantages are particularly appreciated for the manufacture of aircraft and in the present application the expression “composite” should be understood to mean composites of this family of materials comprising inorganic or organic fibers held in a hard organic matrix.

However, aircraft in flight are frequently struck by lightning, the electrical energy of which is sufficient to damage the structure locally, called direct effect of the lightning, which damage must be prevented for obvious reasons of aircraft integrity and for reasons of safety when the structures concerned are structures that must withstand substantial forces, called working structures.

For these reasons, it is known to make the structures made from composite, or more generally structures made of an electrically insulating or poorly conducting material i.e. a material too poorly conductive to be able to disperse the currents induced by the lightning strikes without damaging the structure beyond an acceptable level, electrically conductive on a surface of these structures exposed to the aerodynamic flow and which is also the surface liable to be struck by lightning.

To make the surface of an intrinsically insulating or poorly conductive structure made of a composite electrically conductive, it is known to place electrically conductive metallic elements on the surface that is to be made conductive, these conductive metallic elements being connected to one another from one composite component to another composite component or being connected to an intrinsically conductive metallic structure.

These techniques are referred to using the general term “metallization” which in practice regroups various solutions.

A first known technique consists in placing, on the surface of the composite component, relatively closely spaced conductive metallic strips connected, by at least one of their ends, to a ground plane of the aircraft, and to which strips the lightning will be drawn because of their conductive nature.

The advantage of this solution is that it allows the area covered by the conductive material to be limited while making it possible to provide substantial conductive sections so as to conduct lightning-induced currents, and therefore the electromagnetic transparency of the structure made of a composite is preserved.

Such a “lightning arrestor” strip solution is advantageously employed on airplane radomes but its implementation is difficult and it has the drawback of not protecting all of the surface of the component, in particular when electromagnetic transparency is not required.

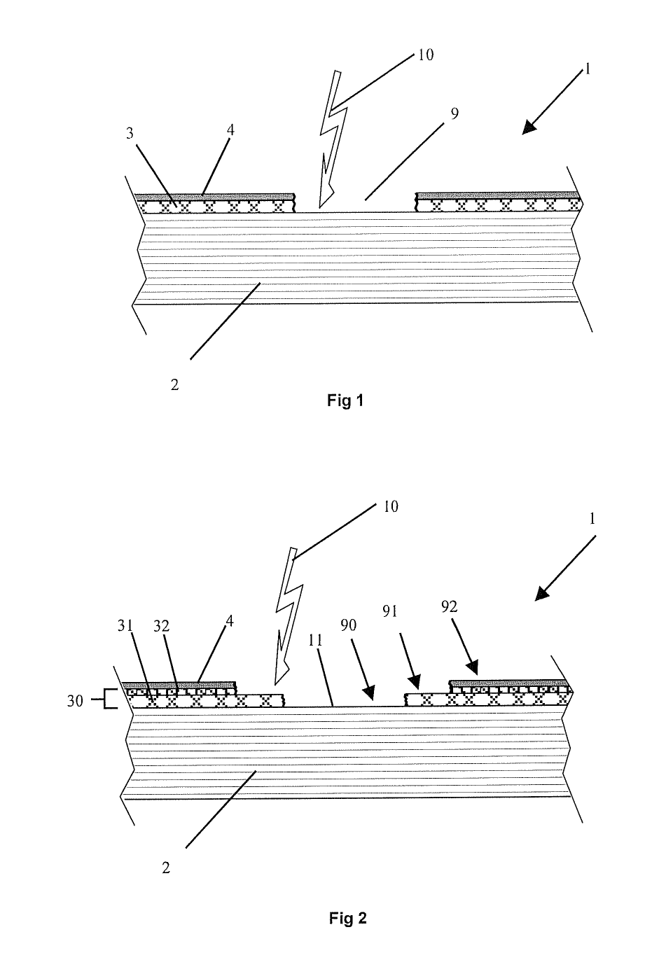

A second known technique, corresponding to the illustration in FIG. 1, consists in covering the entire surface to be protected of the composite structure 2 of a component 1, with a mesh 3 made from an electrically conductive metallic material.

Such a mesh 3 is most often made of bronze or a copper-based alloy or an aluminum-based alloy, in particular because of how well they conduct electricity, either using a conventional process for weaving wires or using a drawing process for obtaining an expanded metal mesh from a sheet.

These meshes 3 are placed on the surface of the component 1 using various techniques, for example placed on the surface of the component during production before a step of hardening the matrix of the composite 2 by polymerization.

In a finishing step, the components produced are painted, not only for esthetic purposes but also to protect the composite 2 of the component from attack by the external environment, such as by moisture or UV radiation.

Paint top coats 4 in general comprise from three to six layers, resulting in a coating of material 150 to 400 μm in thickness, the paint 4 being electrically insulating.

When a component 1 thus metallized is struck by lightning 10, the electric arc perforates the coat of paint 4 as far as the conductive mesh 3 which by electrical conduction transfers the electrical charge and current of the lightning to the structure before the charge can be removed into the ambient air.

Locally, immediately next to the point of impact of the lightning 10, the current densities in the conductive mesh 3 reach very high values and the temperature reached via the Joule effect is sufficiently high to evaporate the metal of the conductive mesh 3.

This vaporization, which absorbs a large amount of the energy of the lightning strike, locally, in a region 9 near the impact, removes the paint 4, via a combined temperature/blast effect, and makes the conductive mesh 3 itself disappear, by vaporization.

This situation is illustrated in FIG. 1 which shows schematically a region of a composite component 1 during a lightning strike.

Analysis of regions having been struck by lightning has shown that the region from which the metallization material has been removed by vaporization corresponds to the region from which the paint has also been removed.

Thus it has been shown that after a first phase of removing the protective metal in the region 9, the root of the lightning arc often attaches itself to the region of the composite 2 then stripped of metallization, and damages the structure. This attachment of the arc root to the composite stripped of metallization is promoted by the fact that the paint 4 masks the remaining conductive mesh 3 and consequently the arc root cannot always immediately attach itself to the conductive mesh 3.

It is therefore apparent that metallization of composite components produced using known techniques provides limited protection that could be improved so as to prevent the structure from being damaged when struck by lightning.

The object of the present invention is precisely to provide a composite component the behavior of which is improved when struck by lightning.

To do this, a component according to the invention comprises a structural, made of an electrically insulating or poorly conductive composite comprising organic or inorganic fibers held in a hard organic matrix, and comprises, on a surface of the structural part, at least on a side of the component liable to be struck by lightning, a metallization layer comprising a layer of a first electrically conductive metallic material, called HVT material, the metallization layer being covered with an electrically insulating protective paint.

The metallization layer of the component furthermore comprises at least a second electrically conductive metallic material, called LVT material, the vaporization temperature Θl of which is lower, even much lower, than the vaporization temperature Θh of the first HVT metallic material so that when struck by lightning local Joule-effect heating by lightning-induced current in the first and second conductive material creates, by vaporizing the second LVT metallic material, a region in which the first HVT material has not been vaporized and in which however the paint has been removed due to the effect of this vaporization.

This region which remains metallized without protective paint, provides improved protection from a lightning strike by promoting attachment of the lightning arc root to the metallization preventing the lightning arc root from attaching itself directly to the composite 2.

In order for the area of the region that remains metallized without protective paint to be sufficient, the LVT and HVT metallic materials are chosen so that the vaporization temperature Θl is below 70% of the vaporization temperature Θh, and preferably so that the vaporization temperature Θl is below 50% of the vaporization temperature Θh.

In practice, on account of the temperatures reached in a metallization layer when struck by lightning, advantageously the LVT and HVT metallic materials are chosen so that the vaporization temperature Θl is below 1250 kelvin and the vaporization temperature Θh is above 2500 kelvin so that the LVT material is vaporized over a substantial area.

Advantageously, to meet these vaporization-temperature conditions while remaining compatible with industrial application of the materials used to produce the metallization layer, the HVT material is a material based mainly on bronze, copper or aluminum and structured in the form of a network of electrically conductive, metallic wires or of an expanded metal or of a metallic foil, and the LVT material is a material based mainly on zinc.

In one embodiment of the metallization layer, the LVT material is located on all or some of one surface of the HVT material, between the HVT material and the protective coat of paint, so as to promote local removal of the protective paint, and/or between the HVT material and the structure made of composite so as to promote partial debonding of the HVT material layer around the point of impact of the lightning.

In a preferred embodiment of the component, the area density of the LVT material is locally, on average, between 10% and 50% of the average local area density of the metallization layer so as to obtain a mechanical vaporization effect that is able to remove the paint and/or the HVT material in the impact region of the lightning and, with regard to optimizing the weight of the metallization, the cumulative conductivity of the electrically conductive materials of the metallization layer is taken into account so as to meet the electrical conductivity requirements of the metallization layer, a condition that is generally easier to meet than protecting against the direct effect of the lightning impact, the invention improving the effectiveness of this protection.

Advantageously, the mass per unit area of the resulting metallization layer is between 50 and 350 g/m².

The present invention also relates to an aircraft structure incorporating one or more components metallized according to the principle described.

Such an aircraft structure is for example a subassembly of the aircraft such as a fuselage or part of the fuselage of an airplane or else parts of the wings or empennage.

The components may be assembled with one another to form a complex subassembly of the aircraft, the composite structure of which is then better protected against the effects of the lightning, and a component or a subassembly is, as required, assembled with other structures of said aircraft, for example metallic structures, or composite structures that do not have the metallization requirements of the components according to the invention.

The detailed description of embodiments of the invention is given with reference to the schematic figures which show:

FIG. 1: mentioned above, a cross section through a region of a component, made of a composite, metallized according to a known technique, having been struck by lightning;

FIG. 2: a cross section through a region of a component, made of a composite, metallized according to one embodiment of the invention, having been struck by lightning; and

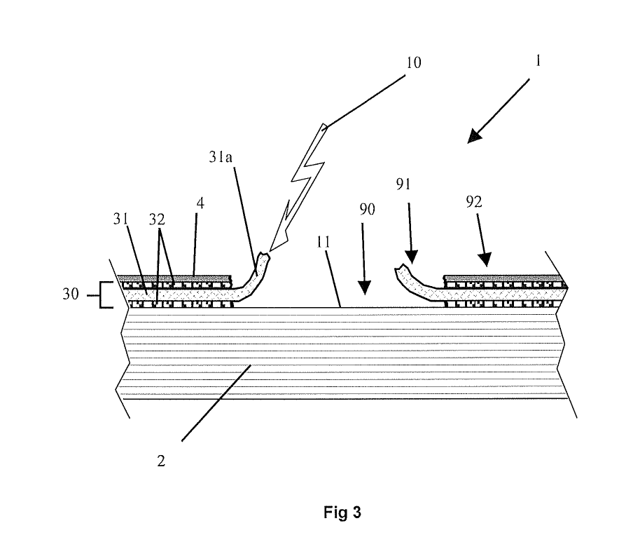

FIG. 3: a cross section through a region of a component, made of a composite, metallized according to another embodiment of the invention, having been struck by lightning.

In FIGS. 1, 2 and 3, similar parts of the component have been given identical references.

A component 1 made of composite according to the invention mainly comprises, as illustrated in cross section in FIGS. 2 and 3, a structural part 2 comprising inorganic or organic fibers held in a hard organic matrix.

Such a structural part 2 is particularly known in aeronautical applications in which a high structural strength/structure weight ratio is required.

For example, such a structure comprises a multilayer of glass-, Kevlar®- or carbon-fiber plies, whether woven or unidirectional, held in a polymer matrix such as an epoxy resin.

In another embodiment (not shown), suited to less heavily loaded structures, for example fairings, the structure comprises, depending on its thickness, a structure with cells, foam or honeycomb structure for example, between two coatings made from fibers held in a matrix.

As is also known, the structure 2 is given the shape of the component 1, for example during a forming process, before it is hardened by curing the material of the matrix, the case for what are called thermosetting matrices, or during a forming process at a temperature for which the matrix is in a plastic state, the case for what are called thermoplastic matrices.

Depending on the case, such a component 1 comprises metallic parts (not shown) such as inserts or reinforcements and/or piercings in particular to meet the fastening requirements of the component.

Such a component 1 is for example what is called a structural component subjected to substantial forces, of the same order under maximum load as the structural strength of the component, for example a fuselage or airplane wing panel, or else what is called a secondary component such as a fairing, for example a fairing between the wing and the fuselage of an airplane.

The component 1 furthermore comprises, on a surface 11 of the component on which electric charge is liable to accumulate and/or on which an electric arc, especially connected with lightning, is liable to occur, a surface layer called a metallization layer 30, the metallization layer itself being covered by a paint top coat 4.

The surface 11 bearing said metallization layer 30 is called a protected surface. In the case of aircraft, it corresponds in particular to the surface of the component 1 on an external side of the aircraft, i.e. the surface exposed to the aerodynamic flow and potentially to lightning strikes 10.

According to the invention, the metallization layer 30 comprises at least two electrically conductive metallic materials 31, 32 having substantially different, possibly in practice very different, vaporization temperature, at least one layer of at least one electrically conductive material 32 of lower vaporization temperature Θl, called LVT conductor, being localized in the metallization layer 30 so that the vapor of the LVT material 32 is able, under the effect of an explosive expansion of said vapor, to tear locally the protective paint 4 away locally, whereas some of the unvaporized layer of the electrically conductive material 31 of higher vaporization temperature Θh, called HVT conductor, stripped of protective paint, remains present on part of the structure.

Such a result is obtained, as shown schematically in FIG. 2, by depositing the metallization 30 during production of the component 1 so that the LVT material 32 is located, on the component produced, under the coat of paint 4, between the coat of HVT material 31 and the coat of paint 4.

However, this schematic representation is not strictly compulsory when in particular the layer of HVT material 31 is produced by means of a network of metallic wires or an expanded metal mesh and when the vapor of the LVT material 32 is able to pass through the layer of HVT material 31 via the many holes in said layer of HVT material.

The conductive HVT material 31 is typically a material similar to the materials used when producing conventional metallizations having a vaporization temperature Θh between 2500 kelvin and 3000 kelvin.

The layer of conductive HVT materials 31 for example takes the form of a mesh of bronze or of copper or of a copper-based alloy or else, if problems with corrosion are to be prevented, in the form of an aluminum or aluminum-alloy mesh or foil, these various materials having vaporization temperatures Θh of about 2800 kelvin.

The conductive LVT material 32 advantageously has a vaporization temperature Θl below about 70%, and preferably below 50%, of the vaporization temperature Θh of the conductive HVT material 31, i.e. in practice a vaporization temperature below 2000 kelvin.

Various metallic materials, for example lead or zinc, meet this condition.

However, in practice the conductive LVT material 32 must also meet various conditions if it is to be used, it must be compatible with the HVT material 31 and meet various criteria, in particular toxicity criteria, which are imposed on industrial manufacturing.

Advantageously, the conductive LVT material 32 is a zinc-based alloy or zinc Zn, the vaporization temperature Θl of which is 1180 kelvin and which has the advantage of being compatible with industrial deposition on bronze, copper or aluminum.

Zinc, the known protection properties of which, against corrosion phenomena, may be taken advantage of, without departing from the scope of the invention, to protect the HVT material 31 from corrosion risks, such as for example in an association of an aluminum-based metallization as HVT material on a composite comprising carbon fibers, is deposited using a conventional technique such as hot-dip galvanizing, zinc electro deposition, zinc spray coating, zinc painting, etc.

The properties of the metallization layer 30, in particular its structure and its average mass per unit area, are determined using known methods of metallization of composites.

In practice an average mass per unit area of metallization between about 50 g/m² and 350 g/m² provides acceptable protection against the effects of lightning with the metallic materials mentioned.

The mass per unit area of the layer of LVT material 32 varies as a function of the required effectiveness which is especially dependent on the solidity of the coat of paint, related inter alia to its thickness. The mass per unit area of the LVT materials lie between 10% and 30% of that of the metallization layer 30, i.e. a mass per unit area between about 10 and 100 g/m², are preferably used, suitable precise values advantageously being confirmed experimentally.

By improving the behavior of the component 1 with respect to direct damage by lightning, i.e. the mechanical effects of lightning near the point of impact, the invention makes it possible to reduce the total weight of the metallization 30 relative to a conventional solution, at least in regions of the components for which the electrical conduction requirements of the metallization, with respect to the indirect effects of lightning, for dispersing lightning-induced currents, are less constraining, which is most generally the case in airplane components.

According to a first embodiment corresponding to the component illustrated schematically in FIG. 2, the LVT material 32 is placed on one face of the characteristic layer of HVT material 31, on the side of the layer of protective paint 4.

In this case the vaporization of the LVT material 32 during a lightning strike causes the paint to be removed locally without significantly affecting the HVT material 31 which is not vaporized.

According to a second embodiment (not shown), the LVT material 32 is placed on the composite structure 2 or on the HVT material 31 between said composite structure and the HVT material 31.

In this case the vaporization of the LVT material 32 during a lightning strike causes the metallization made of HVT material 31 to be debonded locally which is partially lifted up relative to the composite structure 2.

The HVT material 31 thus lifted up promotes attachment of the lightning arc root to said material via the effect of protrusions.

Combining these two embodiments, solution illustrated schematically in FIG. 3, causes, even when the LVT material vapor does not pass through the HVT material, a local debonding 31a of the HVT material 31 itself stripped of protective paint.

In practice when manufacturing the component 1, the layers of HVT and LVT material may be deposited in succession, so as to place them respectively in their required locations on the composite structure 2, for example, as in the embodiment corresponding to the illustration in FIG. 2, and for layers stacked in succession starting with the structural layers, using an operation for depositing a mesh or a film made of HVT material on the structure 2 followed by an operation for depositing a mesh made of LVT material on the layer of HVT material.

According to another embodiment of the component 1, the metallization layer is prepared separately by depositing a layer of LVT material on a layer of HVT material, for example by galvanizing a bronze or copper mesh, and the complex metallization layer thus prepared is deposited on the structure 2 by a conventional metallization method.

In this other exemplary embodiment, the galvanization is advantageously carried out, in an industrial facility, on both sides of the mesh, which results in metallization such as that of the component illustrated schematically in FIG. 3.

When a component 1 metallized according to the invention is subjected to a lightning strike, the temperature reaches locally, near the impact, very high values, exceeding 2500 kelvin, via Joule effect heating because of the very high currents induced in the metallization layer 30 by the lightning having locally passed through the external paint.

Around the point of impact, the lightning-induced current density decreases gradually as a function of the distance from the theoretical point of impact because of the increase in the electrically conductive area of the metallization, which increases with the distance from the point of impact, and the temperature therefore also decreases as a function of the distance from the theoretical point of impact.

Because of the reduction in temperature with the distance from the point of impact, three regions can be defined around the point of impact:
a first region 90 immediately next to the point of impact corresponds to an area of the component, inside of which the temperature reaches or exceeds the vaporization temperature Θh of the HVT material;
a second region 91 surrounding the first region corresponds to an area, inside of which the temperature was below the vaporization temperature Θh of the HVT material but above or equal to the vaporization temperature Θl of the LVT material; and
a third region 92 surrounding the second region corresponds to an area for which the vaporization temperature Θl of the LVT material has not been reached.

These three regions are theoretically concentric but in practice their shape and size are somewhat irregular because of the high sensitivity of lightning effects to many parameters, such as the shape of the component, local defects near the point of impact, the characteristics of the aerodynamic flow, the current-density profile of the lightning, dispersion at the arc root, etc.

Whatever the actual geometry of the various regions after a lightning strike, these various regions may be observed because:
in the third region 92, the protective paint 4 is still present and covers the intact metallization 30;
in the second region 91, the temperature reached makes the electrically conductive LVT material vaporize, leading to the removal of the protective coat of paint 4 and/or debonding of the HVT material 31 from the composite structure 2, but the layer of electrically conductive HVT material 31 is still present; and
in the first region 90, the temperature reached makes the electrically conductive LVT material 32 and therefore also the electrically conductive HVT material 31 vaporize, the coat of paint 4 has therefore also been removed, and the composite 2 of the component has been exposed, it is no longer covered by the metallization or the protective paint.

If the lightning strike is of a lesser severity, it is possible that the temperature reached near the point of impact will not reach the vaporization temperature of the HVT material 31. In this case, the paint will be removed locally, region 91, but a region 90 stripped of metallization will not be created, the component remaining protected.

The invention has the effect therefore of creating the second region 91 which, during the lightning strike, makes it possible to substain the lightening arc, the position of the root of which is particularly unstable, attached to the metallization 30, more particularly to the HVT metallic material 31 still present in said region.

The total region swept by the root of the arc, i.e. the first and second regions 90, 91, is of greater extent than in a conventional metallization solution and the quantity of HVT material 31 vaporized is greater, thereby attenuating the effects of the lightening strike.

Thus, the lightening arc is unable to attach itself to the composite exposed in the region 90, thereby preventing damage to the composite in the region 90.

Components according to the invention are advantageously incorporated in aircraft structures such as fuselage, wing or empennage structures, in particular in the parts of the structures for which the risk of lightning strikes are high or for which the consequences of the effects are judged to be critical, which are then more effectively protected from lightning.

1. A component (1) comprising a structural part made of a composite (2) comprising organic or inorganic fibers held in a hard organic matrix, and comprising, on a surface (11) of said structural part, at least on a side of said component liable to be struck by lightning (10), a metallization layer (30) comprising a layer of a first electrically conductive metallic material (31), said metallization layer being covered with an electrically insulating protective paint (4), characterized in that the metallization layer (30) comprises at least a second electrically conductive metallic material (32), called LVT material, the vaporization temperature Θl of which is below the vaporization temperature Θh of the first electrically conductive metallic material (31), called HVT material.

2. The component as claimed in claim 1, in which the vaporization temperature Θl is below 70% of the vaporization temperature Θh.

3. The component as claimed in claim 2, in which the vaporization temperature Θl is below 50% of the vaporization temperature Θh.

4. The component as claimed in claim 3, in which the vaporization temperature Θl is below 1250 kelvin and the vaporization temperature Θh is above 2500 kelvin.

5. The component as claimed in claim 4, in which the HVT material (31) is mainly bronze, copper or aluminum.

6. The component as claimed in claim 5, in which the HVT material (31) is structured in the form of a network of electrically conductive, metallic wires or of an expanded metal or of a metallic foil.

7. The component as claimed in claim 6, in which the LVT material (32) is mainly zinc.

8. The component as claimed in claim 7, in which the LVT material (32) is located on all or some of one surface of the HVT material (31).

9. The component as claimed in claim 8, in which the LVT material (32) is located essentially on all or some of one surface of the HVT material (31) between the HVT material and the protective coat of paint (4).

10. The component as claimed in claim 8, in which the LVT material (32) is located essentially on all or some of one surface of the HVT material (31) between the composite (2) and the HVT material (31).

11. The component as claimed in claim 8, in which the LVT material (32) is located on the one hand between the HVT material (31) and the protective paint (4) and on the other hand between the HVT material (31) and the composite (2).

12. The component as claimed in claim 1, in which the average area density of the LVT material (32) is locally between 10% and 30% of the average local area density of the metallization (30).

13. The component as claimed in claim 12, in which the mass per unit area of the metallization layer (30) lies between 50 and 350 g/m².

14. An aircraft structure comprising one or more components (1), as claimed in claim 1, assembled with one another and/or with structures of said aircraft.
